(19) United States
(12) Patent Application Publication
(10) Pub. No.: US 2018/0201737 A1
(43) Pub. Date: Jul. 19, 2018

(54) COMPOSITIONS FOR USE IN FUSED FILAMENT 3D FABRICATION AND METHOD FOR MANUFACTURING SAME

(71) Applicant: AREVO, INC., Santa Clara, CA (US)

(72) Inventors: Hemant Bheda, Saratoga, CA (US); Kunal Patel, Pleasanton, CA (US)

(73) Assignee: AREVO, INC., Santa Clara, CA (US)

(21) Appl. No.: 15/922,302

(22) Filed: Mar. 15, 2018

Related U.S. Application Data
(63) Continuation of application No. 14/297,185, filed on Jun. 5, 2014.
(60) Provisional application No. 61/951,720, filed on Mar. 12, 2014.

(51) Int. Cl. C08J 3/00; B29C 64/141; C08J 3/20

(52) U.S. Cl. CPC C08J 3/005; C08J 2469/00; B29C 64/141; C08J 2377/00; C08J 2471/12; B29L 2031/731; C08J 2481/06; C08J 3/203; C08J 2369/00; C08J 2479/08

(57) ABSTRACT

A method for forming a blended material for use as a deposition material in a fused filament fabrication (FFF) printer is provided. A semi-crystalline material and an amorphous material are physically mixed at an appropriate ratio. The mixed material is then heated to a temperature that is above the melting point of the semi-crystalline material and above the glass transition temperature of the amorphous material to form a blended material. The blended material is then extruded through an extruder die for use in the FFF printer.

### CROSS-REFERENCE TO RELATED APPLICATIONS

This application claims the benefit of U.S. Provisional Application Ser. No. 61/951,720, filed Mar. 12, 2014, entitled “COMPOSITIONS AND METHODS FOR USE IN FUSED FILAMENT FABRICATION PROCESSES”, which is incorporated herein by reference, and is a continuation of U.S. application Ser. No. 14/297,185, filed on Jun. 5, 2014, entitled COMPOSITIONS FOR USE IN FUSED FILAMENT 3D FABRICATION AND METHOD FOR MANUFACTURING SAME.

### FIELD OF THE INVENTION

This invention pertains to 3D printing and in particular, materials for use in fused filament fabrication.

### BACKGROUND OF THE INVENTION

Fused filament fabrication (“FFF”), also known as fused deposition modeling, is an additive manufacturing technology typically used for modeling, prototyping, and in some cases even production applications. This process fabricates a three-dimensional (“3D”) object from a mathematical model of the object using materials such as thermoplastics and metals that are typically in the form of a filament. In the case of a thermoplastic material, the object is built by feeding a thermoplastic filament into a heated extrusion head. The thermoplastic is heated past its glass transition temperature and then deposited by the extrusion head as a series of beads in a continuous motion. After deposition, the bead quickly solidifies and fuses with the beads next to and below it. The nozzle of the extrusion head follows a tool-path controlled by a computer-aided manufacturing (CAM) software package, and the object is built from the bottom up, one layer at a time.

The thermoplastics used for fused filament fabrication include, for example, acrylonitrile butadiene styrene (ABS), methyl methacrylate acrylonitrile butadiene styrene copolymer (ABSi), polyphenylsulfone (PPSU), and polycarbonate (PC), among others. A commonality among the aforementioned thermoplastics is that they are all amorphous polymers. Amorphous polymers have a randomly ordered molecular structure. These polymers are characterized by the lack of a distinct melting point; the material increasingly softens and viscosity lowers with increasing temperature. The viscosity at which these amorphous polymers can be extruded is high enough that their shape will be substantially maintained after extrusion, enabling them to solidify rapidly. Also, when the extruded material is deposited on a previously deposited layer during the formation of an object via 3D printing, the two layers readily bond.

Unfortunately, amorphous polymers tend to have poor chemical resistance, lower heat resistance, lower dimensional stability and higher creep. That is why most objects formed via fused filament fabrication cannot be used in more demanding applications such as in aerospace, oil a gas and healthcare industries. Those industries primarily require semi-crystalline material which is conventionally used in an injection molding process to manufacture 3D objects.

However, attempts to “print” the semi-crystalline material with a fused filament fabrication process have been unsuccessful. This is because the highly viscous nature of the material causes clogging in the extrusion printhead and even when printed, the semi-crystalline material does not solidify fast enough to hold its shape.

Therefore, it would be desirable to provide a composition for 3D printing which has better chemical resistance, higher heat resistance, higher dimensional stability and lower creep than the conventional amorphous materials favored in the prior art, such that 3D objects made with the improved composition can be used as a working part in more demanding applications such as in aerospace, healthcare and oil & gas applications. It would also be desirable to provide a method of using the improved composition in 3D printing.

### SUMMARY OF THE DISCLOSURE

In accordance with an illustrative embodiment, a method for forming a blended material for use as a deposition material in a fused filament fabrication printer is provided. A semi-crystalline material and an amorphous material are physically mixed at an appropriate ratio. The mixed material is then heated to a temperature that is above the melting point of the semi-crystalline material and above the glass transition temperature of the amorphous material to form a blended material. The blended material is then extruded through an extruder die for use in the FFF printer. Advantageously, the blended material allows printing of a 3D object with semi-crystalline material to provide increased chemical resistance and superior mechanical strength.

In another aspect of the present invention, a method of operating a FFF printer is provided. A heat blended material adapted to be fed to a FFF printer is provided, wherein the blended material contains an amorphous material and a semi-crystalline material. In the FFF printer, the blended material is heated to a temperature that is above the melting point of the semi-crystalline material and above the glass transition temperature of the amorphous material. A printing head of the FFF printer then deposits the heated material in a selected pattern in accordance with a mathematical model of a 3D object to form the 3D object.

In yet another aspect of the present invention, a composition for use in a fused filament fabrication (FFF) printer is provided. The composition includes a roll of filament adapted to be fed to the FFF printer for printing a 3D object. The filament includes a heated blend of a first amount of a semi-crystalline material and a second amount of an amorphous material, wherein the weight ratio of the first amount to the second amount is 50:50 or higher.

### BRIEF DESCRIPTION OF THE DRAWING

FIG. 1 is a flowchart of a method of fabricating a blended extrudate of amorphous and semi-crystalline materials according to an aspect of the present invention.

FIG. 2 is a flowchart of a method of fabricating a filament roll from the blended extrudate which is suitable to be fed into a fused filament fabrication printer according to an aspect of the present invention.

### DETAILED DESCRIPTION OF THE INVENTION

Printing with the blended material results in 3D objects having more desirable mechanical properties and chemical resistance than would be possible using an amorphous material alone. This results from the presence of the semi-crystalline material in the blend, which is characterized by significantly better chemical resistance and mechanical properties such as tensile strength.

In one embodiment, the blend is a mixture of polyphenylsulfone (PPSU), representing the amorphous polymer, and polyether ether ketone (PEEK) as the semi-crystalline material.

In some other embodiments, other amorphous materials, such as other polyarylsulfones (e.g., polyethersulfone (PESU), polysulfone (PSU), etc.) can be used in conjunction with PEEK to form a blended material in accordance with the present teachings and suitable for use in a fused filament fabrication process. Still further, other amorphous materials can be used in conjunction with PEEK or other semi-crystalline materials to form a blended material in accordance with the present teachings and suitable for use in a fused filament fabrication process. Such other amorphous materials include, for example and without limitation, polyetherimide (PEI), polyphenylene oxides (PPOs), acrylonitrile butadiene styrene (ABS), methyl methacrylate acrylonitrile butadiene styrene copolymer (ABSi), polystyrene (PS), and polycarbonate (PC).

In some other embodiments, polyaryletherketones (PAEKs) other than PEEK can be used as the semi-crystalline component of the blended material. In still further embodiments, other semi-crystalline thermoplastics, for example and without limitation, polyamide (PA), polybutylene terephthalate (PBT), poly(p-phenylene sulfide) (PPS) can be blended with appropriate amorphous thermoplastics to form a blended material in accordance with the present teachings. For example, some other suitable blended materials include PA (semi-crystalline) and PPO (amorphous), PBT (semi-crystalline) and PC (amorphous), and PPS (semi-crystalline) and PEI (amorphous).

In one exemplary embodiment, the weight ratio of semi-crystalline material to amorphous material in the blend is in a range of about 50:50 to about 95:05, inclusive, or about 50:50 to about 90:10, inclusive. Preferably, the weight ratio of semi-crystalline material to amorphous material in the blend is between 60:40 and 80:20, inclusive. In certain applications, however, the weight ratio of semi-crystalline material to amorphous material in the blend could be between 80:20 and 90:10, inclusive, or 80:20 or greater to obtain the most benefit of the superior properties of the semi-crystalline material so long as the blend viscosity is sufficiently high at the operating temperature to preserve its shape upon printing through the extrusion head of the fused filament fabrication printer. The ratio selected for any particular application may vary primarily as a function of the materials used and the properties desired for the printed object.

Since a semi-crystalline polymer by itself has a relatively high viscosity, it would be problematic if not impossible to extrude the material through an extrusion head of a fused filament fabrication printer. However, according to the present invention, the presence of an amorphous polymer in the blend exhibits the relatively more desirable rheological properties characteristic of an amorphous polymer. In other words, the amorphous polymer in the blend decreases the viscosity sufficiently to allow printing of the material through the fused filament fabrication printer.

In another embodiment, the blended material may include two or more semi-crystalline materials and/or two or more amorphous materials. In embodiments in which multiple semi-crystalline materials or multiple amorphous materials are used to form the blended material, the total amount of each type of material (semi-crystalline or amorphous) should fall within the ratio guidelines provided above.

In yet another embodiment, a solid non-polymer filler material having a higher melting temperature than both the amorphous material and semi-crystalline material can be added to the blend to improve mechanical properties of the 3D objects. The amount of the filler material by weight is up to about 60%, and more preferably between 5% and 20% of the total blend. The filler material can include chopped carbon fibers, chopped glass fibers, chopped aramid/Kevlar fibers. Preferably, the fibers are chopped in 1-3 mm in length and are suspended in the blend during its fabrication. In an exemplary embodiment, the chopped fibers are encapsulated or coated with resin.

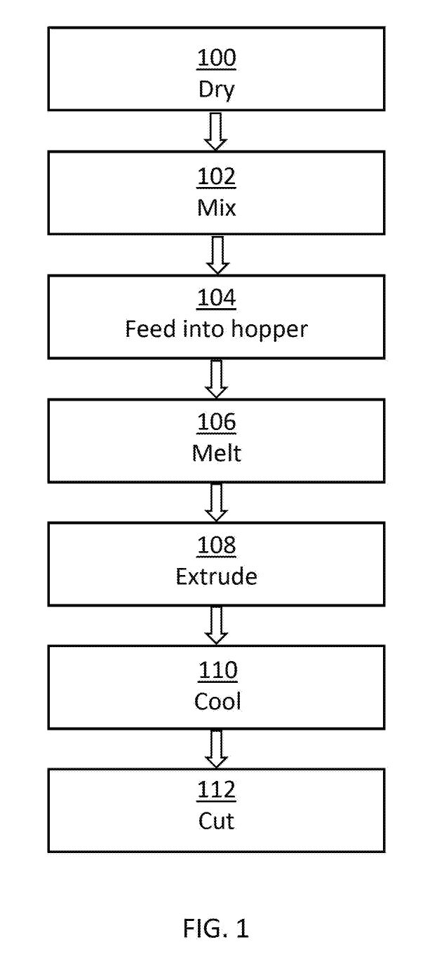

Referring to FIG. 1, the blend is prepared as follows. The materials to be blended are typically provided in pellet or powder form. In step 100, the materials are dried in a dryer to remove moisture in order to prevent hydrolysis of polymer that can reduce polymer chain length resulting in poorer properties. In step 102, the dried materials in powder form are physically and thoroughly mixed in a mixing device. In step 104, the mixed semi-crystalline and amorphous materials are then fed to a hopper of an extruder. In one embodiment, a twin-screw extruder is used to melt blend the materials and then extrude the blended material into a strand.

In case a filler material is used, it can be added during step 102 or 104 or in step 114 as will be discussed later herein. In the extruder, the mixed materials are “melted” (step 106). In accordance with one embodiment, the melt blending is performed at a temperature that is: (a) above the glass transition temperature of the amorphous polymer materials, preferably at a temperature at which the polymer is fluid; (b) above the melting point of semi-crystalline polymer materials; and (c) below the polymer degradation temperature of all amorphous and semi-crystalline materials. In case more than one amorphous polymer material is used in the blend, the melt blending is performed at a temperature that is above the glass transition temperature of all the amorphous polymer materials, at which the polymers behave like a fluid. Likewise, in the case of more than one semi-crystalline polymer materials, the melt blending is performed at a temperature that is above the melting point of all the semi-crystalline polymer materials that are used in the blend.

It has been found that this methodology provides good dispersion of the components and enables good viscosity management (controlling viscosity so that it is in an appropriate range for extrusion) during 3D printing by FFF.

Table 1 below depicts the glass transition temperature (T_{g}) or melting temperature (Tₘ), and the melt processing temperature for several components used in forming blended materials in accordance with the present teachings.

TABLE 1
Glass Transition, Melting, and Melt Processing Temperature

| | | Glass | | Typical Melt |
|---|---|---|---|---|
| | | Transition | Melting | Processing |
| | | Temperature, | Temperature, | Temperature |
| Material | Type | T_{g} (° F.) | Tₘ (° F.) | (° F.) |
| PEEK | Semi-Crystalline | | 650 | 670-700 |
| PPSU | Amorphous | 428 | | 650-750 |
| PEI | Amorphous | 420 | | 660-750 |
| PESU | Amorphous | 437 | | 650-725 |

In step 108, the melted material passes through a die of the twin-screw extruder and is extruded. In one embodiment, the resulting extrudate is typically formed into a strand, which is typically ¼-½ inch in diameter. The melt processing temperature (i.e., the temperature of the material as it is extruded through an extrusion head of a fused filament fabrication printer), as provided in Table 1, will typically be near the temperature at which the materials are melt blended. For example, PEEK (semi-crystalline) and PPSU (amorphous), PEEK (semi-crystalline) and PEI (amorphous), and PEEK (semi-crystalline) and PESU (amorphous) can be melt blended at about 690° F. The melt processing temperature, as per Table 1, will be a similar temperature.

Of course, the melt processing temperature for the blended material will be dictated by the highest melting temperature or highest glass transition temperature of all the amorphous and semi-crystalline materials in the blend, whichever is higher. In the case of the PEEK/PPSU blend, the melting temperature of PEEK is higher than the glass transition temperature of the PPSU. Thus, the melt processing temperature of the blend during printing is in the range of 670-700° F. at the extrusion printhead of the FFF printer.

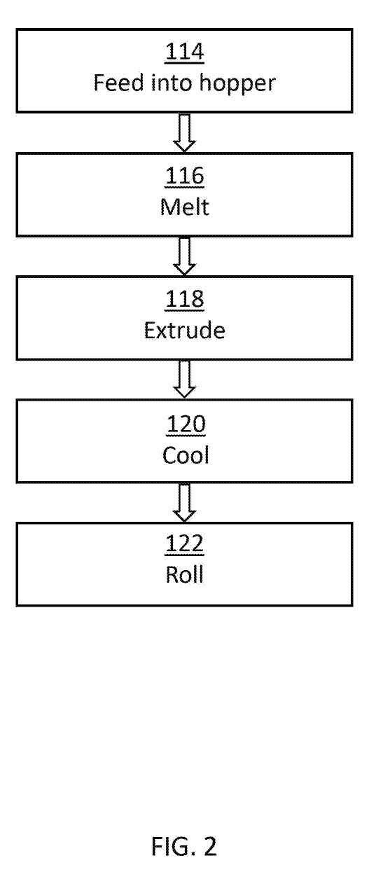

After extrusion, in step 110, the strand is cooled, such as in a water bath. In one embodiment, the size of the extrusion die is such that the strand is in a form of a filament having a diameter of 1-2 mm. The filament is then wound as a roll of filament, which can be fed directly into the FFF printer. Alternatively, in step 112, the strand is cut into small pellets for storage. In that case, the pellets will need to be reprocessed into a filament of 1-2 mm in diameter which is adapted for direct feeding into the FFF printer as illustrated in FIG. 2.

In step 114, the pellets containing the blended materials from step 112 are fed into a hopper of an extruder such as a single or twin-screw extruder. If the filler material is involved, it can be added in this step instead of step 102 or 104. In step 116, the blended pellets are “melted” in the extruder. Similar to step 106, the melting is performed at a temperature that is: (a) above the glass transition temperature of the amorphous polymer materials, preferably at a temperature at which the polymer is fluid; (b) above the melting point of semi-crystalline polymer materials; and (c) below the polymer degradation temperature of all amorphous and semi-crystalline materials. The temperature in the extruder for melting the PEEK (semi-crystalline) and PPSU (amorphous), PEEK (semi-crystalline) and PEI (amorphous), and PEEK (semi-crystalline) and PESU (amorphous) blend is about 690° F.

In step 118, the melted material passes through a die of the extruder and is extruded into a filament, which is typically 1 to 2 mm in diameter. After extrusion, in step 120, the filament is cooled, such as in a water bath and is rolled onto a roll as a final product in step 122, which is suitable to be fed directly into the FFF 3D printer.

To print a 3D object, the filament from the filament roll of the heat blended material is fed to the FFF printer. The filament being fed is then heated by a heater block of the FFF printer to a useable temperature which is above the melting point of the semi-crystalline material and above the glass transition temperature of the amorphous material. The FFF printer then deposits the heated material in a selected pattern layer by layer in accordance with a mathematical model of the 3D object in order to fabricate the 3D object.

As a consequence of the aforementioned desired temperature guidelines, those skilled in the art will appreciate that not all combinations of the aforementioned semi-crystalline thermoplastics and amorphous thermoplastics will be well suited to melt blending for forming the blended material. For example, the thermal transition temperatures should satisfy the aforementioned guidelines and the materials need to be miscible or otherwise compatible. Using this disclosure and readily available reference sources, it is within the capabilities of those skilled in the art to appropriately pair a semi-crystalline thermoplastic and an amorphous thermoplastic to create a blended material in accordance with the present invention.

The above disclosure is intended to be illustrative and not exhaustive. This description will suggest many modifications, variations, and alternatives may be made by people of ordinary skill in this art without departing from the scope of the invention. Those familiar with the art may recognize other equivalents to the specific embodiments described herein. Accordingly, the scope of the invention is not limited to the foregoing specification.

1. A method for forming a blended material for use as a deposition material in an additive manufacturing system, the method comprising:
providing a first amount of a semi-crystalline material and a second amount of an amorphous material;
physically mixing the first amount of the semi-crystalline polyaryletherketone material and the second amount of the amorphous material which includes a polyarylsulfone, wherein the weight ratio of the first amount to the second amount is between 60:40 and 80:20, inclusive;
melt blending using a screw extruder the mixed material at a temperature that is above the melting point of the semi-crystalline material and above the glass transition temperature of the amorphous material to form a blended material; and
extruding the blended material into a strand through an extruder die.

2. The method of claim 1 wherein the screw extruder is a twin-screw extruder.
